(19) United States
(12) Patent Application Publication
(10) Pub. No.: US 2004/0232647 A1
(43) Pub. Date: Nov. 25, 2004

(54) Upper mounting structure of rear strut assembly

(76) Inventor: Ki-Chang Kim, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,219

(22) Filed: Dec. 30, 2003

(30) Foreign Application Priority Data
May 21, 2003 (KR) 2003-0032219

(51) Int. Cl. B60G 15/08

(52) U.S. Cl. 280/124.155

(57) ABSTRACT

An upper mounting structure of a rear strut assembly to which the load of the rear strut assembly is transmitted forms a polygonal section which increases the rigidity. Thereby, reducing the load-concentration transmitted to a wheel housing cover via the rear strut assembly, decreasing running and idle noise, improving the NVH function of the vehicle, shortening the workload by reducing the number of component parts, and decreasing the rate of the fuel consumption by reducing the weight of the vehicle.

### CROSS-REFERENCE TO RELATED APPLICATIONS

This application claims priority of Korean Application No. 10-2003-32219, filed on May 21, 2003, the disclosure of which is incorporated fully herein by reference.

### FIELD OF THE INVENTION

The present invention relates to an upper mounting structure for a rear strut assembly. More particularly, the upper mounting structure is adapted to increase the rigidity of the mounting part while minimizing the components necessary such that noise is dampened and manufacturing cost and workload is decreased.

### BACKGROUND OF THE INVENTION

Typically, in automotive rear suspension systems, a rear strut assembly comprises a shock absorber and a coil spring. The shock absorber and coil spring function to absorb road shock and provide a comfortable ride to the occupants of a vehicle. The rear strut assembly buffers impact forces between the car body and the vehicle wheel while the vehicle is in motion. The rear strut is therefore generally required to be firmly mounted to the car body side, such that the mounting part of the rear strut can obtain enough rigidity to function properly.

### SUMMARY OF THE INVENTION

The present invention provides an upper mounting structure for the rear strut assembly to which the load applied to the rear strut assembly is transmitted. The upper mounting structure is formed with a polygonal section for increased rigidity, thereby, reducing running noise as well as idle noise and improving the Noise, Vibration, and Harshness (NVH) function.

The present invention further provides rigidity via the polygonal section such that the number of component parts is reduced. The present invention also shortens the workload and manufacturing cost and improves the fuel consumption rate of the vehicle by reducing the total weight of the vehicle.

In one embodiment of the present invention, an upper mounting structure of a rear strut assembly comprises a rear wheel housing inner panel. The rear wheel housing inner panel is coupled, for example by welding, to a rear floor panel and an inner section of a quarter inner panel. A wheel housing cover, having a guide hole and bolt holes, is coupled, for example by welding, to the inner side of the rear wheel housing inner panel. This forms a polygonal section with the rear wheel housing inner panel. A reinforcing bracket and a welding nut are mounted, by welding, on the wheel housing cover to couple with the bolt hole.

### BRIEF DESCRIPTION OF THE DRAWINGS

For a better understanding of the nature and objects of the present invention, reference should be made to the following detailed description read in conjunction with the accompanying drawings, in which:

FIGS. 1 and 2 are perspective views illustrating a structure of an upper mounting part of a rear strut assembly according to an embodiment of the present invention;

FIG. 3 is a cross-sectional view taken along line II-II of FIG. 1;

FIG. 4 is a cross-sectional view taken along line III-III of FIG. 1;

FIGS. 5 and 6 are perspective views illustrating another embodiment of a reinforcing bracket according to the present invention;

FIG. 7 is a perspective views illustrating an upper mounting part of a rear strut assembly including a wheel housing reinforcing member according to another embodiment of the present invention; and

FIG. 8 is a cross-sectional view taken along line IV-IV of FIG. 7.

### DETAILED DESCRIPTION OF THE PREFERRED EMBODIMENT

An embodiment of the present invention will now be described in detail with reference to the accompanying drawings.

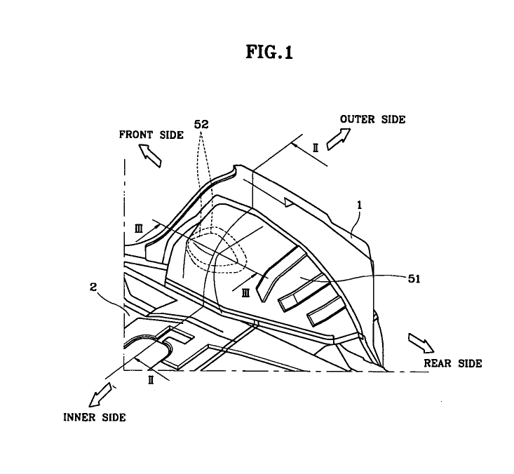

According to FIGS. 1 to 4, an upper mounting structure of a rear strut assembly comprises a rear wheel housing inner panel 51 coupled to a rear floor panel 2 and an inner section of a quarter inner panel 1. It is preferred that the coupling is by welding, however, any other conventional technique is contemplated. Wheel housing cover 52 has a guide hole 52a and a plurality of bolt holes 52b and is coupled to the inner side of the rear wheel housing inner panel 51. In coupling the wheel housing cover 52 to the inner side of the rear wheel housing inner panel 51 a polygonal section, C, is formed. A reinforcing bracket 53 and a welding nut 54 are mounted to the wheel housing cover 52 to couple with the bolt hole 52b. It should be appreciated by one of ordinary skill in the art that the components of the present invention are intended to be coupled by welding of the components, however, any suitable alternative to welding is contemplated by the inventors and may be substituted for the welding.

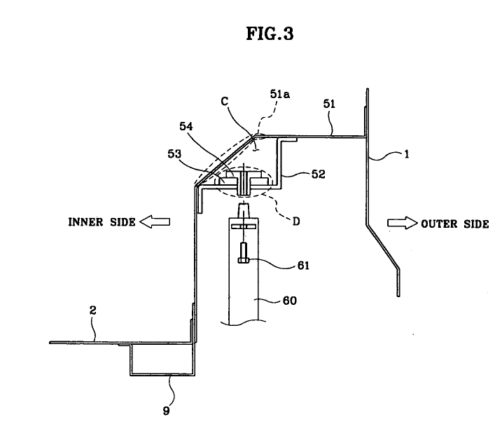

The rear strut assembly 60 (FIG. 3) is mounted in the guide hole 52a formed on the wheel housing cover 52. The strut bolt 61 is inserted into the bolt hole 52b formed near the guiding hole 52a. As shown in FIG. 3, the wheel housing cover 52 is bent in a stair like form to face the inner side of a bent portion 51a of the rear wheel housing inner panel 51. This also forms part of the polygonal section, C, between the bent portion 5la and the wheel housing cover 52.

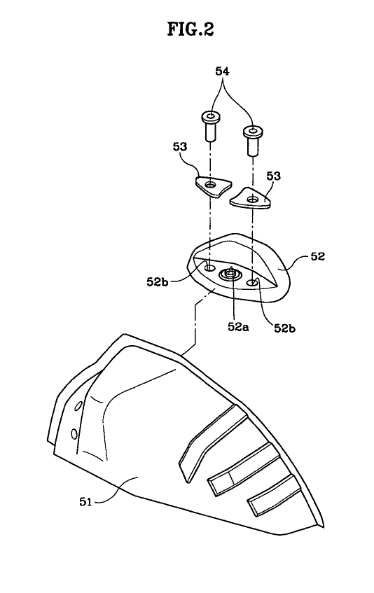

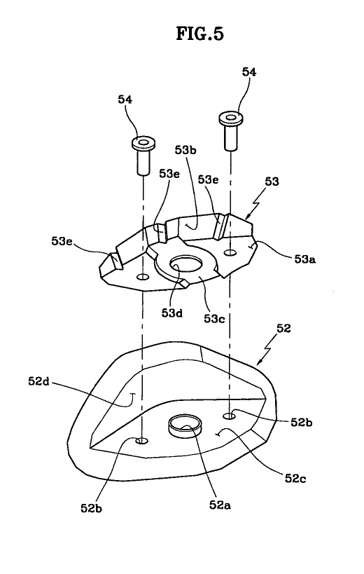

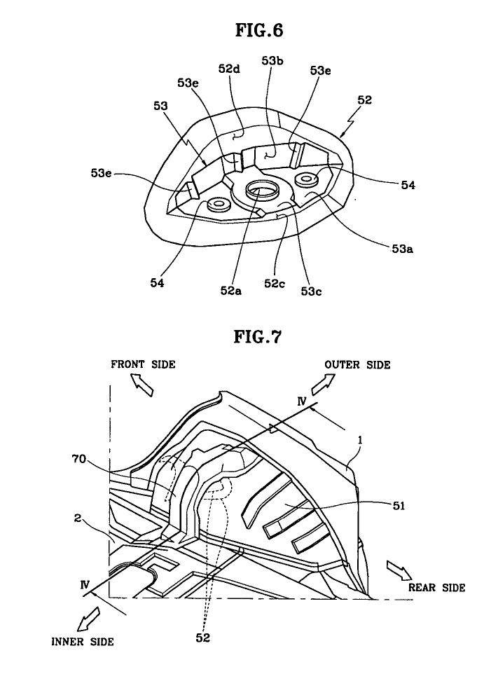

The present invention includes two different types of reinforcing brackets 53. The reinforcing bracket 53 according to an embodiment, shown in FIG. 2, is configured in the form of a triangular plate having a prescribed thickness. As shown in FIGS. 5 and 6, the reinforcing bracket 53 is shown in an alternate configuration. Here the reinforcing bracket 53 includes a horizontal surface portion 53a molded similarly to a horizontal surface 52c of the wheel housing cover 52 for a mating fit. A vertical surface portion 53b is molded to be similar to a vertical surface 52d of the wheel housing cover 52. The reinforcing bracket 53 according to the first embodiment (FIG. 2) is designed to coat only the adjacent portion of the bolt hole 52b of the wheel housing cover 52. The reinforcing bracket 53 according to the second embodiment (FIGS. 5 and 6), however, shrouds the horizontal surface 52c of the wheel housing cover 52 and most of the vertical surface 52d.

The reinforcing bracket 53, according to both the first and second embodiments described above, are different in shape, however, both increase the rigidity of the wheel housing cover 52. The reinforcing bracket 53 may further be formed in other various shapes to increase the rigidity of the wheel housing cover 52.

As shown in FIGS. 5 and 6, the second embodiment of the reinforcing bracket 53 includes a horizontal surface portion 53a that further includes a horizontal reinforcing portion 53c that is generally dome shaped. The horizontal reinforcing portion 53c is also formed with a connecting hole 53d that communicates with the guide hole 52a of the wheel housing cover 52. The vertical surface portion 53b of the reinforcing bracket 53 has a plurality of vertical reinforcing portions 53e that protrude in a triangular shape (in cross-section) toward the horizontal surface portion 53a.

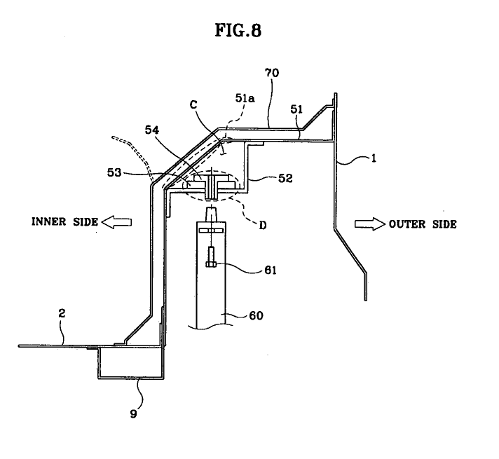

The upper mounting structure of the rear strut assembly can further include a wheel housing reinforcing member 70 as shown in FIGS. 7 and 8. The wheel housing reinforcing member 70 encompasses the wheel housing cover 52 and is formed in a curved manner along the external surface of the rear wheel housing inner panel 51. One end of the wheel housing reinforcing member 70 is coupled, for example by welding, to the rear floor panel 2 and the other end is coupled, for example by welding, to the inner side of the quarter inner panel 1.

According to FIG. 3, rear floor side member 9 is coupled, for example by welding, to the bottom side of the rear floor panel 2 and both ends of the rear floor side member 9 face the front and rear side of the car body.

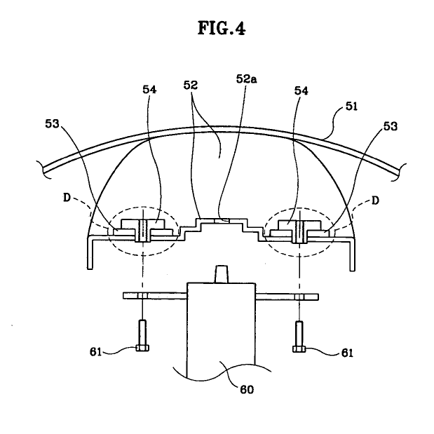

When the upper part of the rear strut assembly 60 is installed with the wheel housing cover 52, by way of the strut bolt 61 and the welding nut 54, the polygonal section, C, formed between the rear wheel housing inner panel 51 and the wheel housing cover 52 increases the rigidity of the installation part (D in FIGS. 3 and 4). Thus, the increased rigidity on the installation part D can reduce the load-concentration transmitted via the rear strut assembly 60 to the wheel housing cover 52.

The welding nut 54 preferably successively passes through the reinforcing bracket 53 and the bolt hole 52b of the wheel housing cover 52. The welding nut 54 also preferably is T-shape and is fastened to the strut bolt 61 which couples the upper portion of the rear strut assembly 60. The T-shaped welding nut 54 functions to increase the rigidity of the upper mounting part of the rear strut assembly 60 with the polygonal section C.

Following coupling of the reinforcing bracket 53 with the wheel housing cover 52, the overall rigidity of the wheel housing cover 52 is increased. Additionally, the rigidity of the upper side of the rear strut assembly 60 is also increased. Placement of the wheel housing reinforcing member 70 also locally increases the rigidity of the installation portion of the wheel housing cover 52 in relation to the rear wheel housing inner panel 51. This also contributes to an increased rigidity of the upper side of the rear strut assembly 60.

There is an advantage in a vehicle applying the structure of the present invention in that running noise and idle noise can be decreased. Furthermore, the NVH function of the vehicle is greatly improved. Another advantage is that the upper mounting part of the rear strut assembly 60, which has an increased rigidity due to the polygonal section, C, does not require additional components for increasing the rigidity. Thereby, the workload on the vehicle is minimized and the fuel consumption rate is increased because the total weight of the vehicle is decreased.

As apparent from the foregoing, an advantage of the present invention is that the rigidity of the upper mounting part of the rear strut assembly is increased. This increase in rigidity leads to effectively reducing the load-concentration transmitted via the rear strut assembly to the wheel housing cover, thereby, improving the NVH function of the vehicle. The NVH function is generally improved by minimizing running noise and idle noise of the vehicle, shortening the workload as a result of fewer components, and decreasing the rate of fuel consumption by reducing the total weight of the vehicle.

What is claimed is:

1. An upper mounting structure of a rear strut assembly comprising:
a rear wheel housing inner panel coupled by welding to a rear floor panel and a quarter inner panel respectively;
a wheel housing cover provided with a guide hole and bolt holes, and coupled by welding to said rear wheel housing inner panel so as to form a polygonal section with said rear wheel housing inner panel; and
a reinforcing bracket and a welding nut mounted by welding on said wheel housing cover to couple with said bolt holes.

2. The upper mounting structure as defined in claim 1, wherein said wheel housing cover is bent in a stair form and installed to face the inner side of a bent portion of said rear wheel housing inner panel and to form a polygonal section between said bent portion and said wheel housing cover.

3. The upper mounting structure as defined in claim 1, wherein said reinforcing bracket takes a form of a triangular plate and is designed to coat only said bolt hole formed on said wheel housing cover.

4. The upper mounting structure as defined in claim 1, wherein said reinforcing bracket including a horizontal surface portion and a vertical surface portion is installed to shroud most of the horizontal surface of said wheel housing cover and the vertical surface of said wheel housing cover.

5. The upper mounting structure as defined in claim 4, wherein said horizontal surface portion of said reinforcing bracket is formed with a horizontal reinforcing portion having a dome shape, and said horizontal reinforcing portion is formed with a connecting hole to communicate with said guide hole of said wheel housing cover, and said vertical surface portion of said reinforcing bracket is formed with a plurality of vertical reinforcing portions that protrude toward said horizontal surface portion.

6. The upper mounting structure as defined in claim 1, wherein said welding nut successively passing through said reinforcing bracket, and said bolt hole of said wheel housing cover is T-shaped.

7. The upper mounting structure as defined in claim 1, further comprising a wheel housing reinforcing member curvedly formed along an external surface of said rear wheel housing inner panel for encompassing an installation portion of said wheel housing cover, and one end of said wheel housing reinforcing member is coupled by welding to said rear floor panel while the other end is coupled by welding to an inner side of said quarter inner panel.

8. An upper mounting structure of a rear strut assembly comprising:
a rear wheel housing inner panel coupled to a rear floor panel and coupled to a quarter inner panel;
a wheel housing cover coupled to said rear wheel housing inner panel so as to form a polygonal section with said rear wheel housing inner panel; and
a reinforcing bracket coupled on said wheel housing cover.

9. The upper mounting structure as defined in claim 8, wherein said wheel housing cover is configured and dimensioned to mate an inner side of said rear wheel housing inner panel and to form a polygonal section.

10. The upper mounting structure as defined in claim 8, wherein said reinforcing bracket is configured and dimensioned as a triangular plate and is designed to couple with said wheel housing cover.

11. The upper mounting structure as defined in claim 8, further comprising a wheel housing reinforcing member curvedly formed along an external surface of said rear wheel housing inner panel for encompassing an installation portion of said wheel housing cover, wherein one end of said wheel housing reinforcing member is coupled to said rear floor panel while the other end is coupled to an inner side of said quarter inner panel.
